(19) United States
(12) Patent Application Publication
(10) Pub. No.: US 2005/0006925 A1
(43) Pub. Date: Jan. 13, 2005

(54) Hardtop vehicle roof

(76) Inventors: Gerald Hahn, Wistedt (DE); Henryk Bork, Hamburg (DE)

Correspondence Address: KLAUS J. BACH, 4407 TWIN OAKS DRIVE, MURRYSVILLE, PA, 15668, US

(21) Appl. No.: 10/912,003

(22) Filed: Aug. 5, 2004

Related U.S. Application Data
(63) Continuation-in-part of application No. PCT/EP03/03150, filed on Mar. 27, 2003.

(30) Foreign Application Priority Data
Apr. 26, 2002 (DE) 102 18 885.8

(51) Int. Cl. B60J 7/14

(52) U.S. Cl. 296/107.07

(57) ABSTRACT

In a vehicle roof comprising at least two roof parts which are movable by a roof operating mechanism between a closed position, in which they cover an interior vehicle space, and an open position, in which they are deposited in a rear storage compartment, and the rear roof part includes a rear window, which is movable relative to the rear roof part by a rear window operating mechanism, the rear window operating mechanism includes a guide slot structure with a guide slot and a slide element guided in the guide slot wherein, for the transfer of the rear window between a sealed position within the rear roof part and a position removed from the rear roof part, the rear window is slidably supported in the guide slot, and a control lever is arranged between the roof operating mechanism and the window operating mechanism such that the rear window movement is coupled with the movement of the roof parts.

This is a Continuation-In-Part Application of International application PCT/EP03/03150 filed Mar. 27, 2003 and claiming the priority of German application 102 18 885.8 filed Apr. 26, 2002.

### BACKGROUND OF THE INVENTION

The invention relates to a hardtop vehicle roof including at least two roof parts which are movable by an operating mechanism between a closed position in which they cover an interior vehicle space and an open position in which the roof parts are deposited in a rear storage compartment, and a rear view window which is disposed in the rear roof part and is movable relative to the rear roof part by a rear window operating mechanism.

A hardtop vehicle roof is disclosed for example in DE 198 07 490 C1. This vehicle roof consists of two rigid roof parts which, in the closed position of the vehicle roof in which the vehicle interior is covered, are disposed in a common roof plane one behind the other. For opening the roof, the roof is moved by a roof operating mechanism into a rear storage compartment. During this procedure, the rear roof part is pivoted about a vehicle body based pivot axis backwardly and the front roof part is pivoted onto the rear roof part.

In order to obtain a compact roof storage packet, in the storage position, the rear window is pivoted relative to the rear roof part from its sealed position in the rear roof part and assumes a position in which it is displaced relative to the rear roof part upwardly out of its sealed disposition in the plane of the rear roof part such that the available trunk space is increased. The rear window is supported in the rear roof part by a pivot joint about which it is pivoted with the aid of a vehicle body based control arm out of its sealed position in the rear roof part into an upwardly pivoted position. The relative movement between the rear window and the rear roof part occurs independently of the opening movement of the vehicle roof.

The relative movement between the rear window and the rear roof part is a pure pivot movement wherein, in the storage position, the plane of the rear window extends at an angle to the plane of the rear roof part. The additional trunk space gained by the pivot movement of the rear window has the shape of an acutely angled sector so that, particularly in the area of the trunk adjacent the back wall of the trunk, only a very small additional storage space is gained.

DE 199 32 503 C2 discloses a hardtop vehicle roof including two rigid roof parts having a movable rear window disposed in the rear roof part. From its closed position, which it assumes when the roof is closed the rear window is movable to an open position in the storage position of the roof. The rear window is pivotally supported on a lower transverse frame of the rear roof part by a rear pivot joint. In the upper area, the rear window is coupled to the C-columns of the rear roof part by way of a slot guide structure. The slot guide structure includes an A-arm which is pivotally connected to a C-column and which carries a slide pin extending into a guide track, which is firmly connected to the rear window. Upon pivoting the rear window about the pivot joint at the lower transverse frame of the rear roof part, the slide element of the A-arm is slidably guided in the guide track. In this way, different opening positions of the rear window can be achieved.

Because the pivot axis of the rear window is disposed at the lower transverse frame of the rear roof part, the possible movement of the rear window relative to the rear roof part is exactly predetermined. The rear window can only pivot about its pivot joint. And the guide track structure can only determine different opening positions of the rear window.

DE 199 36 252 A1 discloses a two-part hardtop whose rear roof part has at opposite sides thereof C-columns between which a rear window is disposed when the vehicle roof is in the closed position. At one end, this rear window is pivotally supported on the vehicle body by a pivot lever which is firmly connected to the rear window and, at its other end, by another pivot lever which comprises two pivot joints by way of which the hardtop roof parts are movable between their end positions. During movement of the vehicle roof into the storage compartment, the rear window pivots about the pivot joint at the vehicle body. The pivot joints of the arms of the operating mechanism and the pivot joint of the rear window at the vehicle body are spaced from each other. During the movement of the roof into the storage compartment this results in different pivot movements of the rear window and the guide arms of the operating mechanism and, consequently, in a relative movement between the rear window and the guide arms. The upper pivotal guide arms firmly guides the upper section of the rear window relative to the guide arms. In this vehicle roof, the rear window is pivotally supported directly on the vehicle body. The movement of the roof parts into the storage compartment depends on the movement of the rear window into the storage compartment since the roof parts are kinematically connected to the vehicle body by way of the rear window.

Also, WO 01/79011 A1 discloses a hardtop vehicle roof with two roof parts whose rear roof part includes a rear window, which is pivotable relative to the rear roof part by way of a front and a rear window support arm wherein the rear window guide arms are pivotally connected to the vehicle body.

It is the object of the present invention to provide a hard top vehicle roof with an adjustable rear window in a simple manner in such a way that with the vehicle roof deposited in the storage compartment, additional usable trunk space is available.

### SUMMARY OF THE INVENTION

In a vehicle roof comprising at least two roof parts which are movable by a roof operating mechanism between a closed position, in which they cover an interior vehicle space, and an open position, in which they are deposited in a rear storage compartment, and the rear roof part includes a rear window, which is movable relative to the rear roof part by a rear window operating mechanism, the rear window operating mechanism includes a guide slot structure with a guide slot and a slide element guided in the guide slot wherein, for the transfer of the rear window between a sealed position within the rear roof part and a position removed from the rear roof part, the rear window is slidably supported in the guide slot.

By way of the guide groove structure, the rear window is securely guided in all phases of its movement during the transfer of the roof between its closed and its storage positions and the concurrent movement of the rear window relative to the rear roof part. The guide groove structure provides, in comparison with the embodiments known from the state of the art, additional design configuration possibilities without increasing the number of degrees of mechanical freedom and with the least possible number of movable parts. With a corresponding selection of the guide slots, purely translatory as well as purely rotational and also mixed translatory and rotational control movements of the rear window with respect to the rear roof part are possible.

In a preferred embodiment, the guide groove on the guide groove structure is rectilinear, particularly if the guide slot structure is firmly connected to the rear roof part and defines with the plane of the roof part a certain angle, for example, 45°. If the guide slot structure is rectilinear, only small forces are effective on the guide slot structure whereby the chances of cogging of the slide element in the guide slot structure is reduced. The angle between the guide slot structure and the plane of the roof element facilitates raising the rear window with respect to the rear roof part.

Expediently, in addition to the guide slot structure, a connection is provided between the rear window and the rear roof part, particularly a control lever, which, at one end is pivotally connected to the rear roof part and, at its other end, is pivotally connected to the rear window. The control lever permits, in addition to the guide-slot-controlled movement a release of the rear window out of its sealed position in the rear roof part, so that in an outwardly pivoted position of the rear window, the rear window is moved fully out of its seat in the rear roof part and can be supported by way of the control lever and the guide slot structure in a position displaced from the rear roof part. Since the rear window can be fully moved out of its seated position in the rear roof part, it can—in a comparison with the state-of-the-art—be raised or lowered relative to the rear vehicle roof part to a greater extent which results in a larger storage volume made available in the trunk of the vehicle.

The relative movement of the rear window with respect to the rear roof part is preferably positively executed dependent on the movement of the vehicle roof. To this end, a control link may be provided which extends between the roof operating mechanism and the rear window operating mechanism. In a preferred embodiment, the control link is pivotally connected with one end thereof to the control arm, which is part of the rear window operating mechanism and, with its other end, to the front roof part whose movement relative to the rear roof part is transferred by way of the control arm to the rear window operating mechanism. No additional drive elements for the relative movement of the rear window are necessary.

Further advantages and suitable embodiments will become apparent from the following description of a particular embodiment of the invention on the basis of the accompanying drawings.

### BRIEF DESCRIPTION OF THE DRAWINGS

FIG. 1a is a side view of a two-part hardtop vehicle roof including a front-and rear roof part, wherein the rear roof part is provided with a rear window which is movable between a sealed position as shown in FIG. 1a and an outwardly pivoted position corresponding to the storage position of the vehicle roof,

FIG. 1b shows an enlarged section of the detail Ib of FIG. 1a, which shows the upper part of the rear window operating mechanism between the rear window and the rear roof part,

FIG. 1c shows enlarged a section Ic of FIG. 1a of the lower part of the rear window operating mechanism which is in the form of a guide slot structure,

FIGS. 2a, 2b and 2c show the corresponding arrangements at the beginning of the transfer movement of the vehicle roof toward the storage position thereof,

FIGS. 3a to 3c show the vehicle roof in a further advanced position toward the storage position thereof and,

FIGS. 4a to 4c show the vehicle roof in the storage position.

### DESCRIPTION OF A PARTICULAR EMBODIMENT

In the figures, identical components are designated by the same reference numerals.

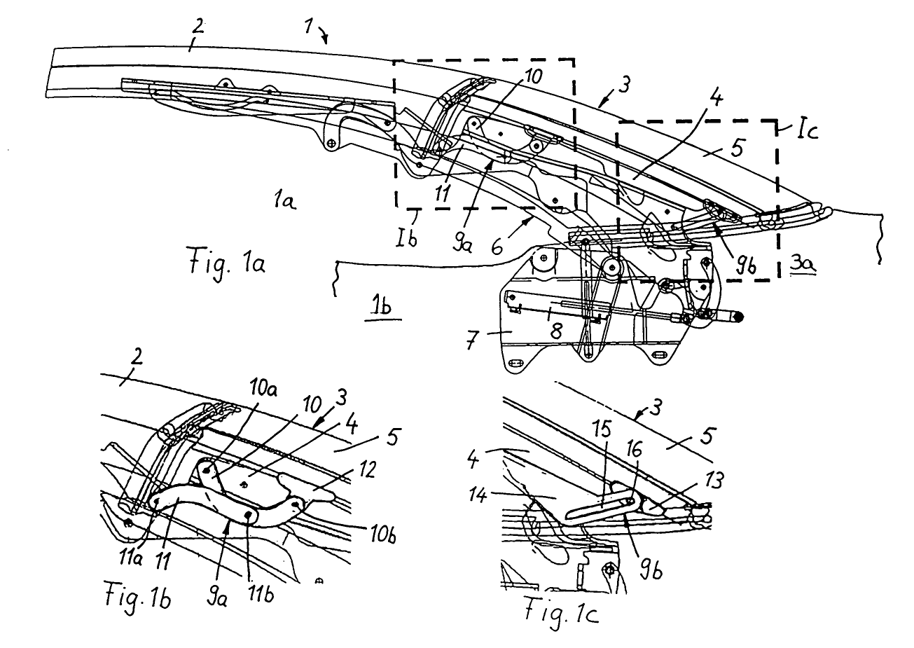

The vehicle roof shown in FIG. 1a is a hardtop vehicle roof 1 including a front roof part 2 and a rear roof part 3, which, in the closed position of the vehicle roof as shown in FIG. 1a, are arranged in the longitudinal vehicle direction one behind the other in a common roof plane. The rear roof part 3 comprises side C-columns 4, between which a rear window 5 is disposed. By way of a roof operating mechanism 6, which is pivotally supported on a console 7 mounted on a vehicle body 1b, the roof parts 2 and 3 can be moved from the closed position as shown in FIG. 1a into a rear storage, or open, position. The roof parts are transferred between the open and closed positions by means of an operating element 8 which is also supported on the console 7 for actuating the roof operating mechanism. The operating element 8 is preferably a hydraulic operating element.

The rear window 5 is connected to the C-columns 4, which are part of the rear roof part 3 by way of a rear window operating mechanism. The rear window operating mechanism comprises an upper part 9a disposed adjacent the rear end of the vehicle. For moving the rear window out of the shown sealed position in a position removed from the rear roof part 3, or respectively, the C-columns 4, the upper part 9a, as well as the lower part 9b, is actuated. The upper part 9a is a pivot or rear window drive structure including an operating arm 10 with a control lever 11 and the lower part 9b is a guide slot structure.

As apparent from the enlarged section as shown in FIG. 1b, the operating arm 10, which is part of the upper rear window operating mechanism 9a, is a partially circular lever which is pivotally connected at its opposite ends by way of joints 10a and 10b. In the area of the joint 10a, the operating arm 10 is pivotally connected to the C-column 4. In the area of the opposite end, the operating arm 10 is pivotally connected by way of the joint 10b to an upper rear window bracket 12, which is firmly mounted to the rear window 5.

The control lever 11, which is also part of the upper rear window operating mechanism part 9a is provided at one end with a joint l1a by way of which the operating arm 11 is pivotally connected to the front roof part 2 or a component which is mounted to the front roof part 2. By way of the control lever 11, the relative movement between the front roof part 2 and the roof part 3 during the transfer of the vehicle roof between the closed and the storage position is transferred to the rear window operating mechanism which provides for the relative movement between the rear window 5 and the C-columns 4.

As apparent from the enlarged section shown in FIG. 1c, the lower rear window operating mechanism part 9b, which is in the form of a guide slot structure comprises a guide slot arm 14, in which a rectilinear guide slot 15 is provided. A lower rear window bracket 13, which is firmly connected to the rear window and which carries a pin 16 extending into the guide slot 15 so as to form a slide element is linearly movable along the guide slot and also rotatable therein. In the closed position of the vehicle roof, in which the rear window 5 is in the sealed position in the rear roof part 3, the guide pin 16 of the lower rear window console 13 abuts a front end of the guide slot 15 in the guide slot arm 14. For the transfer of the rear window into a position removed from the rear roof 3, the pin 16 is slidingly moved along the guide slot 15. The rectilinear guide slot 15 is disposed at an angle with respect to the longitudinal plane of the C-column 4 to which the guide slot arm 14 is firmly connected.

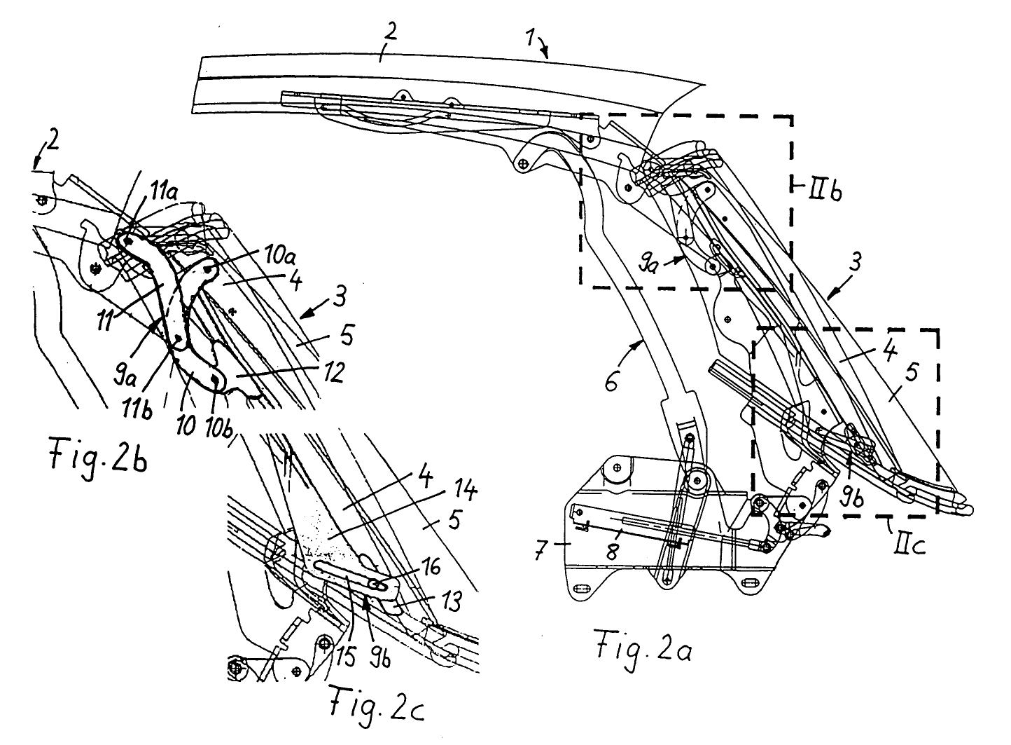

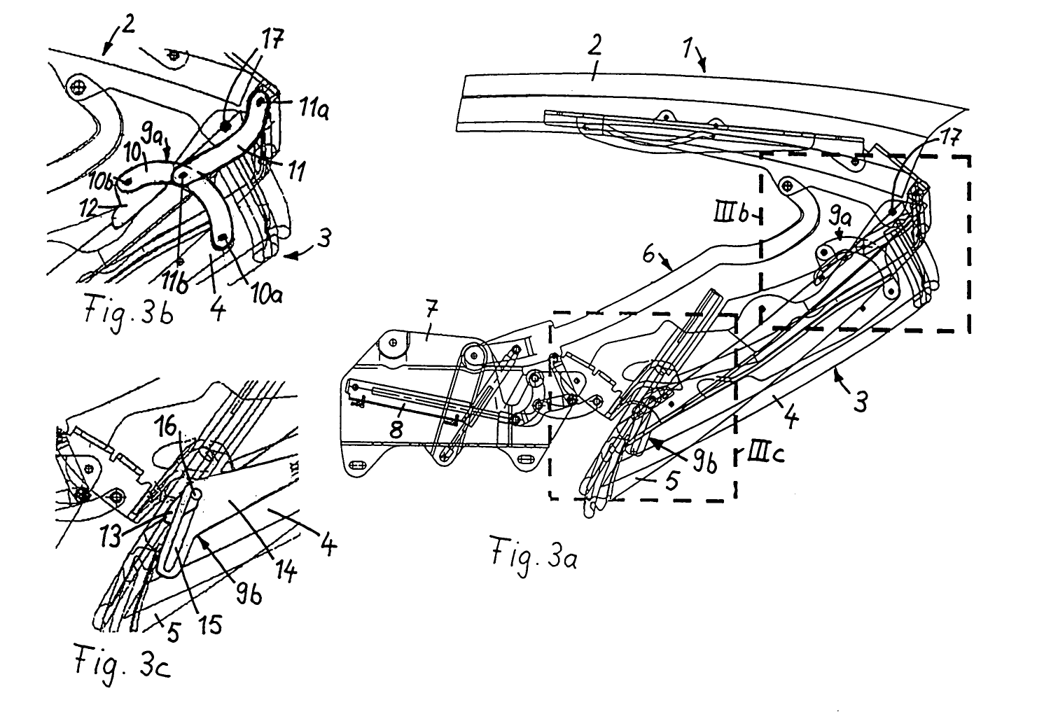

The FIGS. 2a to 2b and 3a to 3c show intermediate positions of the vehicle roof during the transition from the closed position to the storage position. In the first transition position at the beginning of the opening movement as shown in FIGS. 2a-2c, the vehicle roof is only slightly open; the rear window 5 is still close to its sealed position between the C-columns 4. The relative movement between the front roof part 2 and the rear roof part 3 is not sufficiently advanced so that only a small control movement is transmitted by the control lever 11 to the control arm 10. The pin 16 of the lower rear window bracket 13 is close to its end position within the guide slot 15.

With a further movement of the roof 1 from the position as shown in FIGS. 2a to 2c to that shown in FIGS. 3a to 3c, the change in the relative positions between the front roof part 2 and the rear roof part 3 provides for a sufficiently large control movement, which is transmitted by way of the control lever 11 to the control arm 10, which is pivoted so as to move the rear window 5 away from the C-columns 4 and lift it completely out of its sealed position. The movement of the rear window is achieved because of the kinematic coupling between the upper rear window operating mechanism part 9a and the lower rear window operating mechanism part 9b which is obtained by way of the rear window itself or a link extending between the parts 9a and 9b as the pin 16 is moved in the guide slot to the opposite end thereof. During this movement, the rear window 5 is moved in the area of the upper rear window operating mechanism part 9a and also in the area of the lower rear window operating mechanism part 9b out of the sealed position between the C-columns 4 and reaches a position in which it is spaced from the C-columns 4.

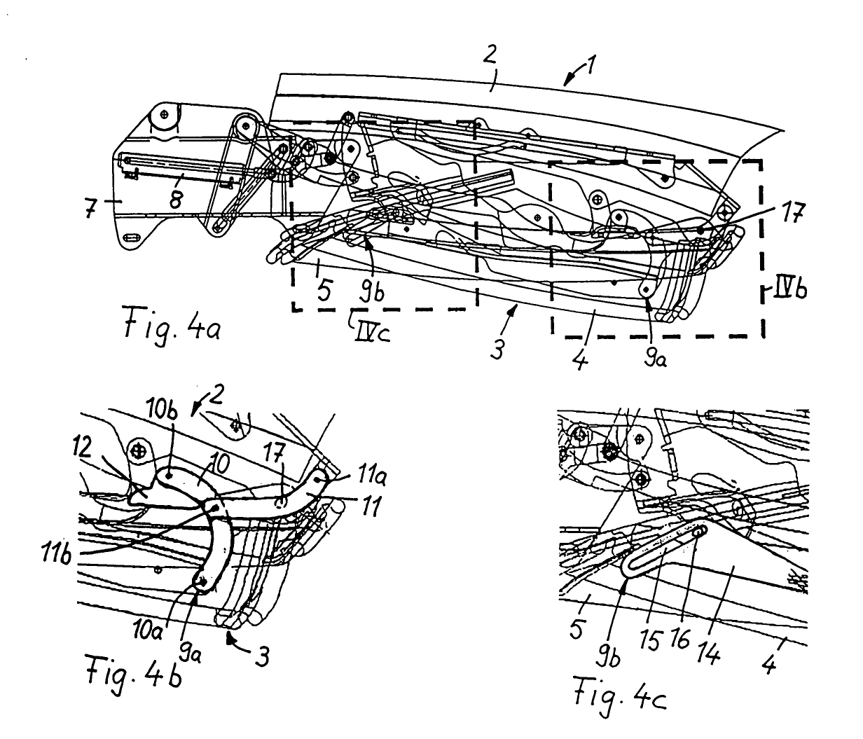

In the storage position as shown in FIGS. 4a to 4c, the rear roof part 3 is disposed in the storage compartment with the outer roof side facing downwardly below the front roof part 2, whose outside surface faces upwardly. The rear window 5 is raised with respect to the C-column 4 and displaced rearwardly in the longitudinal vehicle direction.

In the transition from the advanced transfer position according to FIG. 3a to 3c to the storage position according to FIGS. 4a to 4c a joint 17, which is part of the roof operating mechanism and by way of which the front roof part 2 is pivotally connected to the rear roof part 3, is lowered with respect to the joints 11a and 11b of the control lever 11 to such an extent that the trajectory of the joint 17 passes during the transfer of the roof into the storage position a straight line between the joints 11a and 11b, so that the control lever 11 is disposed with respect to the joint 17 in a over dead center position. When the joint 17 moves beyond the dead center position the pin 16 in the guide slot 15 is moved slightly backwardly. The over-dead center position is a kinematically stable position from which the rear window can be removed only by actuation of the roof operating mechanism.

1. A hardtop vehicle roof (1) including at least two roof parts (2, 3), which are movable by a roof operating mechanism (6) between a closed position in which they cover an interior vehicle space (1a) and an open position in which the roof parts (2, 3) are disposed in a rear storage compartment (3a) of the vehicle, and a rear window (5) supported in sealing engagement with the rear roof part 3 when the roof is in a closed position but being movable relative to the rear roof part (3), a rear window operating mechanism (9a, 9b) including a guide slot (15) and a slide element (16) supported in said guide slot (15) for moving the rear window (5) out of said sealing engagement thereof with said rear roof part (3) guided by said guide slot (15) into a position spaced from said rear roof part (3), a control lever (11) arranged between said roof operating mechanism (6) and said rear window operating mechanism (9a, 9b) wherein, by way of said control lever (11) the rear window movement is operatively coupled to the movement of said roof parts, said rear window operating mechanism (9a, 9b) comprising an operating arm (10) which, with one end thereof is pivotally connected to the rear roof part (3) and, with its other end, is pivotally connected to said rear window (5) and said control lever (11) being pivotally connected to said operating arm (10).

2. A hardtop vehicle roof according to claim 1, wherein said guide slot (15) is formed in a guide slot arm (14) which is connected to said rear roof part (3) and said slide element (16) is connected to the rear window (5).

3. A hardtop vehicle roof according to claim 1, wherein said guide slot (15) is a rectilinear slot.

4. A hardtop vehicle roof according to claim 3, wherein said guide slot (15) extends at an angle with respect to the plane of the rear roof part (3).

5. A hardtop vehicle roof according to claim 1, wherein said operating arm (10) and said guide slot 15 are arranged in the longitudinal vehicle direction one behind the other.
